(19) United States
(12) Patent Application Publication
(10) Pub. No.: US 2026/0327966 A1
(43) Pub. Date: Oct. 22, 2026

(54) DRAINAGE ARTICLE, DRAINAGE DEVICE, METHOD FOR PRODUCING A DRAINAGE ARTICLE AND CONCRETE ARTICLE

(71) Applicant: ACO AHLMANN SE & CO. KG, Büdelsdorf (DE)

(72) Inventors: Martin Clemen, Kiel (DE); Marco Hoppe, Preetz (DE); Robert Schirner, Barkelsby (DE); Ronald Volp, Dollerup (DE)

(21) Appl. No.: 19/110,544

(22) PCT Filed: Sep. 12, 2023
(86) PCT No.: PCT/EP2023/074984

§ 371 Date: Mar. 11, 2025

(30) Foreign Application Priority Data
Sep. 13, 2022 (DE) 10 2022 123 364.2

(51) Int. Cl. E03F 3/04; B28B 7/00; B28B 23/00

(52) U.S. Cl. CPC E03F 3/046; B28B 7/00; B28B 23/0081

(57) ABSTRACT

The invention relates to a drainage article, in particular a channel (10), having at least one drainage body (11) as a single piece from a mortar/concrete mixture (GM), wherein the drainage body (11) includes at least one first region (12) filled by the mortar/concrete mixture (GM), wherein the drainage body (11) has at least a second region (14) with a fine structure (15) and filled by a mortar portion (MA) of the mixture (GM) to form the fine structure (15), wherein, between the two regions (12, 14), at least one transition section (16) is provided which separates at least the concrete portion (BA) of the mixture (GM) in the first region (12) from the mortar portion (MA) in the second region (14).

The invention relates to a drainage article, a drainage device, a method for producing a drainage article, and a concrete article. A drainage article according to the preamble of claim 1 is known, for example, from JP H 11 291 231 A.

Drainage articles, such as channels, inlet boxes, shafts, or similar components used for surface water drainage, can be manufactured in various ways. These articles may be made from a metal material, for instance. However, it is often practical to produce drainage articles from a casting material by pouring it into a mold. This process results in highly stable cast bodies. Concrete material is often used as a casting material.

For example, this is the case with JP H 11 291 231 A mentioned above, in which a U-shaped channel is formed from precast concrete. During production, the ready-mixed concrete is filled from above into a formwork that forms the U-shaped channel. Due to its viscosity, the cement paste in the ready-mixed concrete tends to adhere to the mold surfaces on the inside of the channel. This creates a cement-rich, less sandy mortar layer along the mold surfaces. As a result, the surface of the inner side of the U-shaped channel is covered with the mortar layer and forms a smooth surface.

Furthermore, EP 0 009 056 A1 discloses a tubular component which is formed using a concrete mortar. During the production of the component, concrete mortar is poured from above into a mold and compacted by vibrating or shaking.

Another example of a drainage element made of concrete is described in DE 20 2016 105 078 U1, wherein the drainage element is used as a cover, for example, for a channel element. The drainage element has several longitudinal webs between which drainage openings are formed.

Drainage articles, such as those described above, often include fine structures with thin wall thicknesses. These fine structures may include connectors for pipelines, projections, locking recesses, or similar features. However, producing such structures with the required quality is challenging. In practice, experts in the field generally consider that the wall thickness of the structure to be formed should be at least three times the size of the largest aggregate in the concrete material. This presents the disadvantage that when using coarse-grained concrete, the fine structures must be designed with correspondingly large wall thicknesses. Otherwise, the fine structures may not be adequately filled with concrete during manufacturing, leading to rough and imprecise contours. Additionally, such fine structures exhibit reduced stability.

Accordingly, the object of the invention is to provide a drainage article with at least one fine structure that offers increased stability and improved surface quality. The invention further aims to provide a drainage system, a method for manufacturing a drainage article, and a concrete article. According to the invention, this object is achieved with respect to the drainage article by the subject matter of claim 1 or claim 10. With respect to the drainage system, the method, and the concrete article, the object is achieved by the subject matter of claim 12 (drainage system), claim 13 (method), and claim 17 (concrete article).

The stated object is specifically achieved by a drainage article, particularly a channel, comprising at least one drainage body monolithically formed from a mortar/concrete mixture. The drainage body includes at least a first region, which is filled with the mortar/concrete mixture and at least a second region with a fine structure, which is filled with the mortar portion of the mixture to form the fine structure. At least one transition section is provided between the two regions, which at least separates the concrete portion in the first region from the mortar portion in the second region.

A key aspect of the invention is that the second region of the drainage body, and thus the fine structure, is formed by the mortar portion of the mortar/concrete mixture. This offers the advantage that, unlike the first region of the drainage body, the fine structure has a finer material composition. Preferably, the fine structure is nearly completely filled with the mortar portion of the mixture, resulting in minimal to no voids and, consequently, an improved surface quality. This is particularly advantageous when the fine structure includes at least one functional surface that is required to be especially smooth. Additionally, the fine structure exhibits increased stability. Preferably, the material of the mortar portion in the fine structure is homogeneously distributed. The drainage body preferably includes multiple second regions, each with at least one fine structure.

It is known from the prior art that concrete material contains aggregates with larger grain sizes compared to mortar material. In other words, concrete is coarser than mortar, allowing mortar to be used to create finer, i.e., smaller, structures. Fundamentally, any concrete material can include a mortar portion. However, components manufactured from concrete are typically designed with a wall thickness that is at least three times the size of the largest aggregate in the concrete material. This presents the disadvantage that fine structures can only be produced with poor quality, reduced stability, or may not be feasible at all.

An advantage of the drainage article according to the invention is that the drainage body is formed from a mixture of mortar and concrete and is monolithically formed. The drainage body is formed as a single piece. In other words, the drainage body is monolithic.

According to the invention, the mixture includes at least one concrete portion and at least one mortar portion, which are mixed. The mortar/concrete mixture thus constitutes a dual-material composition with at least one concrete portion and at least one mortar portion. Preferably, both the concrete and mortar portions include at least one binder, at least one aggregate as a mineral filler, and water. For example, the binder may be cement, lime, gypsum, clay, synthetic resin, and/or lime-cement. Sand and/or gravel may be used as the mineral aggregate. Other binders and aggregates may also be used. Additionally, polymer concrete may be employed in the mortar/concrete mixture.

Preferably, the concrete portion contains an additional aggregate material in addition to the aggregate of the mortar portion, wherein the additional aggregate has a larger grain size than the aggregate in the mortar portion. Alternatively, the additional aggregate in the concrete portion may be the same as that in the mortar portion but with at least a larger grain size.

The concrete portion preferably additionally includes the granular material of the mortar portion. In other words, in addition to the further granular material of larger grain size, the concrete portion preferably includes all components of the mortar portion. Stated differently, the concrete portion comprises the same granular material as the mortar portion, with the concrete portion additionally including at least one further granular material, in particular a larger granular material, with a grain size greater than a, particularly the maximum, grain size of the granular material in the mortar portion. The further granular material may be the same mineral aggregate as that of the mortar portion or a different mineral aggregate.

According to the invention, the first and second regions of the drainage body are distinguished in that the first region is formed from the mortar/concrete mixture, i.e., the concrete and mortar portions, while the second region consists of the mortar portion. Particularly preferably, the second region consists solely of the mortar portion of the mortar/concrete mixture. In other words, the fine structure is preferably formed solely from the mortar portion of the mixture. The drainage body preferably has a wall thickness in the first region that is greater than the wall thickness in the second region. Stated differently, the fine structure preferably has a wall thickness that is less than that of the first region. The first region preferably comprises a coarse structure, i.e., at least one section with a greater wall thickness than the fine structure.

The first region may, for example, form a base body, in particular a foundation, of the drainage article. Specifically, the base body may include at least one guide section for directing a liquid, such as water. It is possible for the first region to include a channel structure. Alternatively or additionally, the first region may form the base body of an inlet box or a shaft. Other base bodies of drainage articles are also possible.

Within the scope of the invention, the fine structure is understood to be a structurally formed shape that preferably has at least a smaller wall thickness than the shape of the drainage body in the first region. The fine structure preferably comprises a thin-walled form in the second region. The fine structure is preferably at least one contour projecting from the drainage body. Preferably, the fine structure is formed as at least one thin-walled contour. The fine structure may include a functional surface, particularly a contact surface and/or a sealing surface. The fine structure preferably has a smooth external contour.

The fine structure is preferably a functional element of the drainage body. The fine structure, in particular the functional element, may include at least one projection and/or at least one rib. Alternatively or additionally, the fine structure, particularly the functional element, may comprise at least one channel frame, at least one locking recess, and/or at least one connecting projection for joining two adjacent drainage bodies.

A transition section is provided between the first region and the second region. In other words, the transition section is located between the first and second regions. The transition section forms the area where the first region of the drainage body transitions into the fine structure. Preferably, the transition section is a plane positioned between the two regions. In the transition section, the concrete portion is separated from the mortar portion. In other words, on the side of the first region, the mortar/concrete mixture borders the transition section, while on the side of the fine structure, only the mortar portion of the mixture borders the transition section. Stated differently, the transition section forms a separation between the mortar/concrete mixture in the first region and the mortar portion of the mixture in the fine structure.

Alternatively, the transition section may be a volume region into which grains of the further granular material of larger grain size from the concrete portion extend from the side of the first region. The remaining volume of this region is filled with the mortar portion of the second region, particularly the fine structure. Preferably, the volume region is substantially completely filled with the mortar portion of the fine structure. Thus, it is possible for the transition section to be at least partially part of the second region, i.e., the fine structure.

The transition section is preferably arranged at the base of the fine structure. The transition section preferably forms a transition from a larger wall thickness of the first region to a smaller wall thickness of the fine structure.

Preferably, the drainage article is a channel for surface drainage. Alternatively, the drainage article may be part of an inlet box for point drainage. As another alternative, the drainage article may be provided as part of a shaft. In general, the drainage article is used either as a standalone component or as part of a drainage system designed for surface water removal. Alternatively, the drainage article may be used as part of an access shaft. Other applications are also possible.

In a preferred embodiment, the mortar portion and the concrete portion of the mixture each include at least one bound granular material. As described above, the bound granular material of the concrete portion and the mortar portion is the same, with the concrete portion preferably including an additional granular material of larger grain size. Preferably, the maximum grain size of the granular material in the mortar portion is smaller than the minimum grain size of the additional granular material in the concrete portion. In other words, the concrete portion includes an additional, particularly larger, granular material with a grain size that is greater than the grain size of the granular material in the mortar portion. Particularly preferably, the grain size of the granular material in the concrete portion is larger than the grain size of all the granular material in the mortar portion. Furthermore, the fine structure is preferably free of grains from the additional granular material in the concrete portion. In this embodiment, the concrete portion includes two granular materials with different maximum grain sizes.

In another preferred embodiment, the fine structure has at least one wall thickness and at least one depth, where the ratio of depth to wall thickness is less than or equal to 1:1. This configuration refers to the cross-section of the fine structure. In other words, the fine structure has a length extending from the drainage body that is greater than or equal to its wall thickness. The depth or length of the fine structure is understood to be in the longitudinal direction, i.e., in the extension. direction of the fine structure. In this embodiment, the fine structure forms a protruding element or shape due to its depth or length. An advantage of this is that the fine structure is sufficiently large to allow an adequate amount of the mortar portion to form it. As a result, voids are reduced during the manufacturing process, thereby improving surface quality. Additionally, the fine structure is formed with increased stability.

Preferably, the fine structure and/or the transition section includes at least one constriction, in particular a reduced wall thickness. In other words, the transition section and/or the fine structure may include a material constriction. Preferably, the constriction, particularly the reduced wall thickness, is smaller than the minimum grain size of the additional granular material in the concrete portion. This provides a clear separation between the mortar/concrete mixture in the first region of the drainage body and the fine structure.

Furthermore, the transition section preferably has, at least in sections, a wall thickness that is smaller than the minimum grain size of the additional, particularly larger, granular material in the concrete portion. Additionally or alternatively, the wall thickness of the fine structure is smaller than the minimum grain size of the additional granular material in the concrete portion. In other words, the fine structure preferably consists of the granular material of the mortar portion, while the additional granular material of the concrete portion is absent. The advantage of this is that the fine structure has a smooth surface while maintaining high structural stability due to its nearly void-free material composition.

The first region preferably has, at least in sections, a wall thickness greater than the grain size, particularly the maximum grain size, of the additional, especially larger, aggregate material contained in the concrete portion. The first region is formed by the mortar/concrete mixture. Thus, the first region forms a coarse structure that adjoins the fine structure. The first region preferably has a wall thickness greater than the wall thickness of the fine structure and/or the transition section. Due to the relatively coarse material structure compared to the fine structure, the first region of the drainage body is designed to be robust.

Preferably, the minimum grain size of the additional, particularly larger, aggregate material in the concrete portion is at least 2 mm, particularly ranging from 2 mm to 32 mm. It is possible for the additional aggregate material in the concrete portion to contain grains of varying sizes, all of which are at least 2 mm. An essential feature of this embodiment is that the smallest grain in the aggregate material of the concrete portion is at least 2 mm. The minimum grain size of the additional aggregate material in the concrete portion may range from 4 mm to 20 mm, preferably from 4 mm to 10 mm, and more preferably from 4 mm to 8 mm. This ensures that, during manufacturing, none of the additional aggregate material in the concrete portion fills the fine structure; only the mortar portion, with its finer aggregate material, does so.

Furthermore, the maximum grain size of the aggregate material in the mortar portion is preferably 2 mm or less. In other words, the largest grain in the aggregate material of the mortar portion has a maximum size of 2 mm. This implies that the aggregate material may also include grains with sizes ranging between 0 mm and 2 mm. As a result, during manufacturing, only the mortar portion, with its fine aggregate material, fills the fine structure.

The wall thickness, particularly at the narrow section of the transition section and/or the fine structure, is preferably smaller than the grain size of the aggregate material in the concrete portion. The wall thickness, particularly at the narrow section of the transition section and/or the fine structure, may be smaller than the minimum grain size of the additional aggregate material in the concrete portion. The wall thickness, particularly at the narrow section of the transition section and/or the fine structure, may be up to 12 mm. The wall thickness, in particular the narrow section, of the transition section and/or the wall thickness of the fine structure is preferably a maximum of 4 mm, more preferably a maximum of 2 mm, in particular a maximum of 1.8 mm, preferably a maximum of 1.6 mm.

It is possible that the wall thickness, in particular the narrow section, of the transition section and/or the wall thickness of the fine structure is a maximum of 1.5 mm, in particular a maximum of 1.2 or a maximum of 1.0 mm. It is essential that the grain size of the aggregate in the concrete portion is larger than the wall thickness of the fine structure and/or the transition section, particularly at the narrow section. In this context, the grain size of the concrete portion may refer to the (minimum) grain size of the larger aggregate within the concrete.

A secondary aspect of the invention relates to a drainage element, particularly a channel, featuring at least one drainage body monolithically formed from a mortar/concrete mixture. This drainage body includes at least one guide section designed for directing liquids, preferably water. The guide section comprises at least one surface area with a surface roughness characterized by a roughness average Ra of no more than 0.7 μm.

The drainage article exhibits a particularly high surface quality in the guide section for liquid drainage. During use, this prevents or at least significantly reduces the adhesion of dirt and, consequently, the formation of deposits. In the case of a drainage channel, for example, the surface section may form part of the channel base.

In a particularly preferred embodiment, the surface section of the guide section has, at least in some areas, a surface roughness with an roughness average Rₐ of less than or equal to 0.4 μm, preferably a maximum of 0.2 μm. This enhances the fluidity of the liquid while further reducing the risk of deposits. Additionally, the smooth surface increases the service life of the drainage article by minimizing potential points of attack, thereby reducing chipping and spalling.

In another preferred embodiment, the drainage body also includes at least one exterior surface, preferably multiple exterior surfaces, with a surface roughness featuring an roughness average Rₐ of less than or equal to 0.7 μm. This exterior surface is smooth, providing an aesthetically pleasing appearance for the drainage body.

Preferably, the surface section of the guide section and/or the exterior surface has a surface roughness with an roughness average Rₐ ranging from 0 μm to 0.7 μm, preferably from 0 μm to 0.6 μm, and more preferably from 0 μm to 0.5 μm. It is also possible for the surface section of the guide section and/or the exterior surface to have a surface roughness with an roughness average Rₐ ranging from 0 μm to 0.4 μm, more preferably from 0 μm to 0.3 μm. Alternatively, the surface section of the guide section and/or the exterior surface may have a surface roughness with an roughness average Rₐ ranging from 0 μm to 0.2 μm, more preferably around 0.1 μm.

It is also possible for upper surfaces, particularly upper edges, of a drainage channel body—such as a monolithic channel or channels with at least one monolithic frame—to have surfaces with a surface quality featuring an roughness average of less than 0.4 μm, preferably a maximum of 0.2 μm. Advantageously, such smooth surfaces reduce the accumulation of contaminants.

In another independent aspect, the invention relates to a drainage device comprising at least one drainage article of the type described above.

In a further independent aspect, the invention relates to a method for manufacturing a drainage article, preferably a drainage channel, using at least one mold to form the drainage article. The mold comprises at least a first area, at least a second area with a fine structure, and an intermediate retention area. In the method according to the invention, a mortar/concrete mixture is provided and poured into the mold, whereby the mortar/concrete mixture fills the first area of the mold and the retention area retains the concrete portion the mixture in such a way that a mortar portion of the mixture fills the second area of the mold to form the fine structure. In other words, the fine structure is formed by a mortar portion of the mixture.

The method according to the invention is preferably used for manufacturing one of the drainage articles described in the invention. Alternatively, the method may be used to manufacture a concrete article, particularly a light well, a shoe scraper tray, a separator, a pumping station, and/or a lifting station, or similar structures.

The retention area serves to form a transition section of the drainage article. It determines the wall thickness of this transition section. Preferably, the retention area has a maximum passage width smaller than the minimum grain size of the additional aggregate material in the concrete portion. In other words, the retention area preferably has a maximum passage width that is greater than or equal to the maximum grain size of the aggregate material in the mortar portion. The retention area forms the negative mold for the transition section of the drainage body. When the mold is filled with the mortar/concrete mixture, the retention area holds back the larger grains of the additional aggregate material in the concrete portion, allowing only the fine-grained mortar portion to flow into and fill the second region.

In a preferred embodiment of the method according to the invention, the spatial distribution of the mortar portion and/or the concrete portion of the mixture within the mold is controlled by the retention area. In other words, the retention area is preferably designed to allow the passage of the mortar portion while ensuring that the concrete portion remains entirely within the first region.

In another preferred embodiment of the method according to the invention, the retention area includes at least one constriction that allows the mortar portion of the mixture to pass through during the filling process while at least partially retaining the concrete portion.

In one embodiment, the retention area includes at least one sieve material and/or at least one filter material designed to allow the mortar portion of the mixture to pass through while at least partially retaining the concrete portion. This enables the realization of fine-structure wall thicknesses that retain aggregate articles larger than the minimum grain size of the additional aggregate material in the concrete portion, while still ensuring that the fine structure is formed exclusively by the mortar portion.

Regarding the dimensions of the retention area and the mold in the fine-structure region, reference is made to the previously described dimensions, particularly the value ranges, concerning the transition section and the fine structure of the drainage body. Since the mold preferably forms the negative shape of the drainage body, it preferably has the corresponding described internal dimensions.

According to another independent aspect, the invention relates to a concrete article intended for civil engineering, structural engineering, landscaping, wastewater treatment, and/or building technology. The concrete article comprises at least one base body, which is monolithically formed from a mortar/concrete mixture. The base body has at least a first region that is filled with the mortar/concrete mixture. Additionally, the base body includes at least one second region with a fine structure, which is filled with the mortar portion of the mixture to form the fine structure. At least one transition section is provided between the two regions, which at least separates the concrete portion in the first region from the mortar portion in the second region.

The concrete article may have one or more features of the previously described preferred embodiments of the drainage article. Specifically, the base body of the concrete article may include one or more features of the previously described preferred embodiments of the drainage body of the drainage article. In general, the first area, the second area with the fine structure, and the transition section of the concrete article may include one or more features of the previously described preferred embodiments of the first area, the second area with the fine structure, and the transition section of the drainage body of the drainage article. The same applies to the mortar/concrete mixture.

The concrete article may, for example, constitute at least part of a light well, a shoe scraper tray, a separator, a pump station, and/or a lifting system. Other concrete articles are also possible. Further advantages of the drainage system, the method, and the concrete article can be found in the advantages discussed in connection with the drainage article. Additionally, the drainage system, the method, and the concrete article may, alternatively or additionally, feature individual or a combination of multiple characteristics previously mentioned concerning the drainage article. The invention is described in greater detail below with further specifics, referring to the accompanying drawings. The illustrated embodiments provide schematic examples of how the drainage article according to the invention may be designed.

### In These Drawings:

FIG. 1a shows a top view of a drainage article according to a preferred exemplary embodiment of the invention;

FIG. 1b shows an end view of the drainage article according to FIG. 1a;

FIG. 2 presents a detailed view of a longitudinal section of the drainage article according to FIG. 1; and

FIG. 3 illustrates a cross-section of the drainage article according to FIG. 1 in a schematic representation.

In the following specification, identical and functionally equivalent components are designated with the same reference numerals.

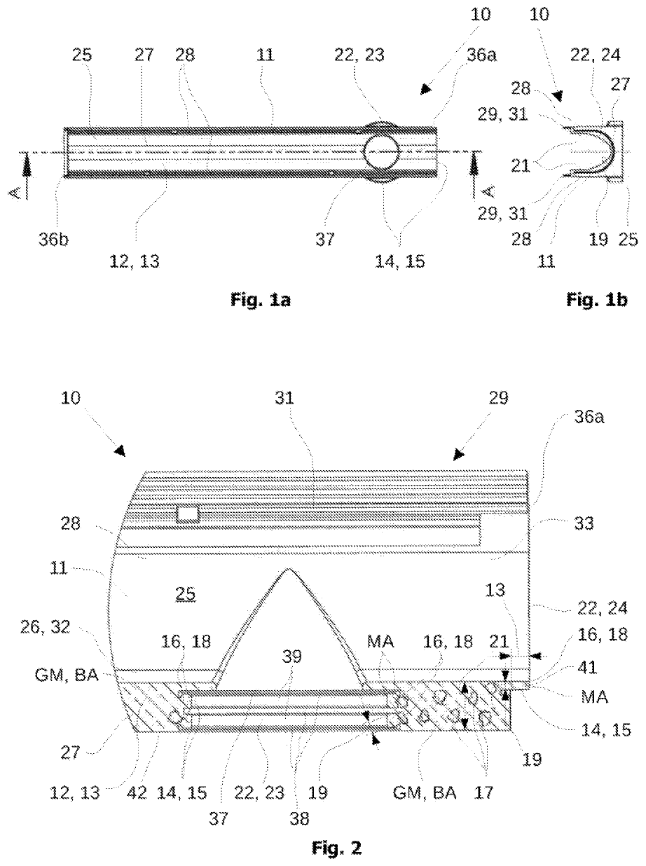

FIG. 1a shows a top view of a drainage article according to a preferred exemplary embodiment of the invention. Specifically, the drainage article is a channel (10) for surface drainage. The channel (10) comprises a drainage body (11), hereinafter referred to as the channel body (11). The channel body (11) is monolithic in design. In other words, the channel body (11) is formed as a single piece. The channel body (11) consists of a cured mortar/concrete mixture (GM). The specific manufacturing process of the channel body (11) is discussed in greater detail later.

The channel body (11) has an elongated shape. It includes a channel base (27), which forms the foundation of the channel body (11). Additionally, the channel body (11) features two sidewalls (28) that are positioned opposite each other and extend upward, in particular substantially perpendicularly, from the channel base (27). Specifically, in the installed position, the sidewalls (28) stand on the channel base (27). The channel base (27) and the sidewalls (28) extend along the longitudinal direction of the channel body (11). The channel base (27) and the sidewalls (28) are formed as a single piece.

As shown in FIG. 1b, the upper edges (29) of the sidewalls (28) each include a shoulder (31), more preferably a frame, designed to accommodate, for example, a channel cover. The shoulder (31), particularly the frame, may be part of an insert or an integral component of the monolithic channel body (11). Alternatively, the channel body (11) may include a channel cover section monolithically integrated with the channel bottom (27) and the side wals (28), which cover section connects the two upper edges (29) of the sidewalls (28). The channel cover and the channel cover section preferably feature through-holes to allow surface water to flow into the channel (10).

According to FIGS. 1a and 1b, the channel (10) includes a guide section (25) for directing surface water. The guide section (25) is located between the two side walls (28) and is bounded on the underside by the channel bottom (27). In other words, the channel bottom (27) and the two side walls (28) enclose the guide section (25). The guide section (25) extends along the entire length of the channel body (11). The guide section (25) comprises a channel base (32) as well as the inner surfaces (33) of the side walls (28). As shown in FIG. 3, the guide section (25) includes multiple surface sections (26, 34, 35) with different surface qualities, which will be discussed in more detail later.

The channel body (11) of the channel (10) features a first region (12) that is completely filled with the mortar/concrete mixture (GM). Additionally, the channel body (11) includes multiple second regions (14), which are only filled with the mortar portion (MA) of the mortar/concrete mixture (GM). In other words, the first region (12) consists of a cured mortar/concrete mixture (GM), while the second region (14) consists of a cured mortar portion (MA) of the mortar/concrete mixture (GM). The first region (12) includes at least the channel bottom (27) and the side walls (28). The second regions (14) each contain a fine structure (15), which is filled with the mortar portion (MA). Specifically, this means that the channel bottom (27) and the side walls (28) are formed by the mortar/concrete mixture (GM), while the fine structures (15) are formed by the mortar portion (MA) of the mortar/concrete mixture (GM).

The mortar/concrete mixture (GM) used to form the channel body (11) consists of a concrete portion (BA) and a mortar portion (MA), which are mixed together. The mortar/concrete mixture (GM) is a dual material. Both the concrete portion (BA) and the mortar portion (MA) include a binder, at least one mineral aggregate, and water. For example, the binder may be cement, lime, gypsum, clay, synthetic resin, and/or lime cement. The mineral aggregate may include sand and/or gravel, although other binders and aggregates are also possible.

The concrete portion (BA) contains all the constituents of the mortar portion (MA). The mortar portion (MA) includes a granular material with a maximum grain size of 2 mm as its mineral aggregate. In other words, the largest grain in the granular material of the mortar portion (MA) is 2 mm or smaller. Preferably, the granular material of the mortar portion (MA) has a grain size of less than 2 mm. This same mineral aggregate or granular material is also present in the concrete portion (BA). Additionally, the concrete portion (BA) contains grains with a grain size greater than 2 mm. These grains are part of an additional, preferably coarser, granular material (17). The additional granular material (17) may be the same mineral aggregate as that in the mortar portion (MA) or a different mineral aggregate. The grain size of the additional granular material (17) in the concrete portion (BA) may range from 2 mm to 32 mm, preferably from 4 mm to 8 mm. It is essential that the smallest grain in the additional granular material (17) of the concrete portion (BA) is larger than 2 mm.

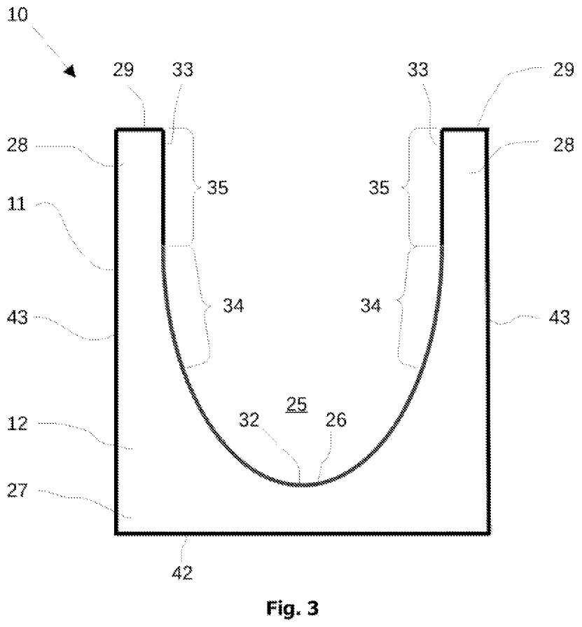

FIG. 2 shows a detailed section of a longitudinal cut through the channel as shown in FIG. 1a and FIG. 1b. The channel (10) has two longitudinal ends (36a, 36b), with the detailed section illustrating the channel (10) in the area of the first longitudinal end (36a), where the second regions (14), i.e., the fine structures (15), are located. Essentially, the first fine structure (15) forms a connection (23) with a connection contour (22), for example, for a piping system.

As clearly visible in FIG. 2, the channel body (11) has a through-opening (37) formed in the channel bottom (27). The through-opening (37) extends from the guide section (25) through the channel bottom (27). The channel body (11) features a first fine structure (15) on an inner surface (38) facing the through-opening (37). The first fine structure (15) comprises two ribs (39) surrounding the through-opening (37). The ribs (39) may also be referred to as grooves or ribs. In other words, the first fine structure (15) on the inner surface (38) of the channel body (11) consists of two ring-shaped ribs. In general, the ribs (39) have a wall with a specific wall thickness.

As also clearly visible in FIG. 2, the channel body (11) includes a transition section (16) between the first fine structure (15), specifically between the ribs (39), and the adjacent first section (12), i.e., the channel bottom (27). This transition section (16) separates the cured mortar/concrete mixture (GM) from the cured mortar portion (MA). The transition section (16) corresponds to a plane that spans between the channel bottom (27) and the ribs (39). The transition section (16) forms a boundary between the first region (12) and the first fine structure (15) of the channel body (11).

The channel bottom (27) and/or the side walls (28) each have a minimum wall thickness, preferably a minimum thickness, which is greater than a maximum wall thickness (19), or maximum thickness, of the ribs (39). In other words, the ribs (39) each have a maximum wall thickness (19) that is smaller than a minimum wall thickness of the channel bottom (37) and/or the side walls (28). FIG. 2 shows a wall thickness (21) of the channel bottom (37), which is exemplary of the wall thickness in the first region (12) of the channel body (11) and is greater than the wall thickness (19) of the fine structures (15). The maximum wall thickness (19) of the ribs (39) may be less than or equal to 4 mm. The minimum wall thickness of the channel bottom (27) and/or the side walls (28) may be greater than 4 mm.

The maximum wall thickness (19) of the ribs (39) is smaller than the minimum grain size of the additional granular material (17) in the concrete portion (BA) of the mixture (GM). In other words, the maximum wall thickness (19) of the ribs (39) is smaller than the smallest grain of the additional granular material (17) in the concrete portion (BA). Conversely, the maximum wall thickness (19) of the ribs (39) is greater than or equal to the maximum grain size of the granular material in the mortar portion (MA). In other words, the maximum wall thickness (19) of the ribs (39) is greater than or equal to the largest grain in the granular material of the mortar portion (MA).

As shown in FIG. 2, the ribs (39) have a constant wall thickness along their entire length. The constant wall thickness of the ribs (39) thus corresponds to the maximum wall thickness of the ribs (39). The transition section (16) also comprises the maximum wall thickness (19) of the ribs (39). The transition section (16) may include a constriction (18) that is smaller than the minimum grain size of the additional granular material (17) in the concrete portion (BA). As can be seen in FIG. 2, the ribs (39) each have an aspect ratio of their wall thickness (19) to their depth (13) of approximately 1:1. In other words, the ribs (39) essentially have a square cross-sectional shape.

The minimum wall thickness of the channel bottom (27) and/or the side walls (28) is greater than the maximum grain size of the additional granular material (17) in the concrete portion (BA). Thus, the largest grain of the additional granular material (17) in the concrete portion (BA) is smaller than the minimum wall thickness of the channel bottom (27) and/or the side walls (28).

FIG. 2 depicts a second fine structure (15) at the first longitudinal end (36a) of the channel body (11), which serves as a connecting projection (24) for joining the channel body (11) with another channel body (11). The connecting projection (24) has a substantially rectangular cross-sectional shape and extends in a U-shape on the front face of the first longitudinal end (36a). The connecting projection (24) forms a U-shaped rib (41) that protrudes from the front face of the first longitudinal end (36a). The rib (41) has a sealing surface on its inner side. The rib (41) has a wall with a specific wall thickness.

As clearly visible in FIG. 2, the channel body (11) also features a transition section (16) between the second fine structure (15), i.e., between the rib (41) and the adjacent first region (12), which includes the channel bottom (27) and the side walls (28). Here as well, the transition section (16) corresponds to a plane spanning between the channel bottom (27), the side walls (28), and the rib (41). The transition section (16) forms a boundary between the first region (12) and the second fine structure (15) of the channel body (11).

Like the ribs (39) of the first fine structure (15), the rib (41) has a maximum wall thickness (19) that is smaller than the minimum wall thickness of the channel bottom (37) and/or the side walls (28). The maximum wall thickness (19) of the rib (41) may be smaller or the same between 4 mm and 9 mm. The minimum wall thickness of the channel bottom (27) and/or the side walls (28) may be greater than 4 mm.

The maximum wall thickness (19) of the rib (41) is smaller than the minimum grain size of the additional granular material (17) in the concrete portion (BA) of the mixture (GM). In other words, the maximum wall thickness (19) of the rib (41) is smaller than the smallest grain of the additional granular material (17) in the concrete portion (BA). Conversely, the maximum wall thickness (19) of the rib (41) is greater than or equal to the maximum grain size of the granular material in the mortar portion (MA).

As shown in FIG. 2, the rib (41) has a wall thickness that tapers outward in cross-section. The maximum wall thickness (19) is present at the base of the rib (41), where the transition section (16) is located. In other words, the transition section (16) has the maximum wall thickness (19), while the rib (41) generally has a smaller wall thickness, for example, 4 mm.

In general, the channel (10) according to FIGS. 1a to 3 may have only a fine structure (15) formed from the mortar content (MA) of the mixture (GM) or more than two fine structures (15) formed from the mortar content (MA) of the mixture (GM).

In the channel body (11) according to FIGS. 1a to 3, all surfaces exhibit particularly high surface quality, except for an outer surface of the channel bottom (27), which is not externally confined by a mold or formwork during the casting process. This outer surface corresponds to the at least partially exposed casting surface (42) of the channel body (11). All other surfaces of the channel body (11) have a surface quality with a roughness average Rₐ of less than or equal to 0.7 μm.

Specifically, the guide section (25) of the channel body (11) has a first surface section (26) with a surface quality characterized by a roughness average Rₐ of 0 μm to 2 μm. This surface section (25) forms a channel base (32) of the guide section (25). The sidewalls (28) each have, on their inner surface (33), a second surface section (35) with a roughness average Rₐ of at most 0.7 μm, preferably at most 0.4 μm. Between the first and second surface sections (26, 35), the guide section (25) has a third surface section (34) that forms a transition between the first and second surface sections (26, 35). The third surface region (34) has a surface quality with a roughness average Rₐ of at most 0.7 μm, preferably at most 0.4 μm.

Likewise, the top surface (29) of the sidewalls (28) and the outer surfaces (43) of the sidewalls (28) have a surface quality with a roughness average Rₐ of at most 0.7 μm, preferably at most 0.4 μm. The same applies to the end faces of the channel body (11) at the two longitudinal ends (36a, 36b). It is also possible for the top surfaces, in particular the top surfaces (29) of the sidewalls (28). of a channel body-such as a monolithic channel or channels with a monolithic frame-to have surfaces with a surface quality characterized by a roughness average of less than 0.4 μm, preferably at most 0.2 μm.

The following describes a method for manufacturing the channel (10) according to FIGS. 1a to 3. In a first step, a mold is provided to form the channel (10). Preferably, the mold is formwork-based. In other words, the mold is preferably formed using formwork. The mold represents a negative of the channel (10) to be produced. The mold has a first region that reproduces all other features of the channel (10) except for the first and second fine structures (15). These features include, among others, the channel bottom (27) and the two sidewalls (28). Furthermore, the mold has two second regions that define the two fine structures (15) of the channel (10). The second region of the mold defining the first fine structure (15) has an internal dimension corresponding to the wall thickness of the first fine structure (15). The second region of the mold defining the second fine structure (15) has an internal dimension corresponding to the wall thickness of the second fine structure (15).

Additionally, a retention area is formed between the first region of the mold and the fine structures (15). This retention area is designed to hold back the concrete portion (BA), specifically the grains of the additional granular material (17) within the concrete portion (BA), when the mold is filled with the mortar/concrete mixture (GM). The retention area may take the form of a constriction that prevents the grains of the additional granular material (17) within the concrete portion (BA) from entering the second region. The retention area of the mold defines the transition section of the finished channel (10). The retention area has the aforementioned dimensions of the transition section in relation to grain size and wall thickness. Accordingly, the retention area serves to spatially distribute the concrete portion (BA) and/or the mortar portion (MA) of the mixture (GM).

The mold is provided in such a way that it is at least partially open at the top. In a second step, mortar/concrete mixture (GM) is poured into the mold. The mortar/concrete mixture (GM) completely fills the first region of the mold, forming the channel bottom (27) and the sidewalls (28). The retention area of the mold holds back the grains of the additional granular material (17) within the concrete portion (BA) in such a way that the mortar portion (MA) of the mixture (GM) completely fills the second regions of the mold to form the fine structures (15), i.e., the surrounding ribs (39) and the U-shaped rib (41). The mold may also include additional second regions for forming further fine structures.

As an alternative or in addition to the constriction, the retention area of the mold may include sieve material and/or filter material to hold back the grains of the additional granular material (17) within the concrete portion (BA).

### REFERENCE LIST

10 Channel
11 Channel body
12 First region
13 Depth
14 Second region
15 Fine structure
16 Transition section
17 Granular material of the concrete portion
18 Constriction
19 Wall thickness of the fine structure or transition section
21 Wall thickness of the first region
22 Connection contour
23 Connection
25 Guide section
26 Surface section of the guide section
27 Channel bottom
28 Side walls
29 Upper side of the sidewalls
31 Shoulder
32 Channel base
33 Inner side of the sidewalls
34 Surface section in the transition
35 Surface section of the inner side of the sidewalls
36a First longitudinal end
36b Second longitudinal end
37 Through opening
38 Inner surface
39 Ribs of the first fine structure
41 Ribs of the second fine structure
42 Casting surface
43 Outer surfaces of the side walls
GM Mortar/concrete mixture
MA Mortar portion
BA Concrete portion
Rₐ Roughness average

What is claimed is:

1. Drainage article, comprising at least one drainage body (11), which is monolithically formed from a mortar/concrete mixture (GM), wherein the drainage body (11) has at least a first region (12) that is filled with the mortar/concrete mixture (GM),
wherein the drainage body (11) comprises at least a second region (14) with a fine structure (15), which is filled with a mortar portion (MA) of the mixture (GM) to form the fine structure (15), wherein at least one transition section (16) is provided between the two regions (12, 14), which at least separates the concrete portion (BA) of the mixture (GM) in the first region (12) from the mortar portion (MA) in the second region (14).

2. Drainage article according to claim 1,
wherein the mortar portion (MA) and the concrete portion (BA) of the mixture (GM) each comprise at least one bound granular material, wherein a maximum grain size of the granular material in the mortar portion (MA) is smaller than a minimum grain size of another, granular material (17) in the concrete portion (BA).

3. Drainage article according to claim 1,
wherein the fine structure (15) has at least a wall thickness (19) and a depth (13), where the ratio of wall thickness to depth is less than or equal to 1:1.

4. Drainage article according to claim 1
wherein the fine structure (15) and/or the transition section (16) has at least one reduced wall thickness.

5. Drainage article according to claim 1,
wherein the fine structure (15) and/or the transition section (16) has, at least in sections, a wall thickness (19) that is smaller than the minimum grain size of the additional granular material (17), which is present in the concrete portion (BA) and is in particular larger in size.

6. Drainage article according to claim 1,
wherein the first region (12) has, at least in sections, a wall thickness (21) that is greater than the grain size of the additional, granular material in the concrete portion (BA).

7. Drainage article according to claim 2,
wherein the minimum grain size of the additional, granular material (17) in the concrete portion (BA) is greater than or equal to 2 mm.

8. Drainage article according to claim 2
wherein the maximum grain size of the granular material in the mortar portion (MA) is less than or equal to 2 mm.

9. Drainage article according to claim 1,
wherein the fine structure (15) comprises at least one functional element, for joining two adjacent drainage bodies or similar components.

10. Drainage article, comprising at least one drainage body (11), which is monolithically formed from a mortar/concrete mixture (GM), wherein the drainage body (11) includes at least one guide section (25) for directing fluids,
wherein the guiding section (25) comprises at least one surface segment (26), which has, at least in sections, a surface roughness with a roughness average Rₐ of less than or equal to 0.7 μm.

11. Drainage article according to claim 10,
wherein the surface section (26) of the guide section (25) has a surface roughness with a roughness average Rₐ of less than or equal to 0.4 μm, at least in certain sections.

12. Drainage system (100) comprising at least one drainage article, according to claim 1.

13. Method for manufacturing a drainage article, having at least one mold for forming the drainage article, wherein the mold comprises at least a first region, at least a second region with a fine structure, and a retention area located between them, wherein in the method, a mortar/concrete mixture (GM) is provided and filled into the mold, with the mortar/concrete mixture (GM) filling the first region of the mold and the retention area retaining the concrete portion (BA) of the mixture (GM) in such a way that a mortar portion (MA) of the mixture (GM) fills the second region of the mold to form the fine structure.

14. Method according to claim 13,
wherein the spatial distribution of the mortar portion (MA) and/or the concrete portion (BA) of the mixture (GM) in the mold is controlled by the retention area.

15. Method according to claim 13
the retention area comprises at least one constriction (18) in such a way that, during the filling process, the mortar portion (MA) of the mixture (GM) passes through while at least the concrete portion (BA) of the mixture (GM) is retained.

16. Method according to claim 13
wherein the retention area comprises at least one sieve material and/or at least one filter material in such a way that, during the filling process, the mortar portion (MA) of the mixture (GM) passes through and at least the concrete portion (BA) of the mixture (GM) is retained.

17. Concrete article comprising at least one base body (11) formed monolithically from a mortar/concrete mixture (GM), wherein the base body (11) comprises at least a first region (12) filled with the mortar/concrete mixture (GM),
wherein the base body (11) comprises at least a second region (14) with a fine structure (15), which is filled with a mortar portion (MA) of the mixture (GM) to form the fine structure (15), wherein at least one transition section (16) is provided between the two regions (12, 14), separating at least the concrete portion (BA) of the mixture (GM) in the first region (12) from the mortar portion (MA) in the second region (14).
